(19) United States
(12) Patent Application Publication
(10) Pub. No.: US 2012/0131237 A1
(43) Pub. Date: May 24, 2012

(54) EXTENSION DEVICE AND COMMUNICATION CHECK METHOD

(75) Inventors: Masanori NAGANUMA, Kawasaki (JP); Takashi Sawakuri, Kawasaki (JP); Shotaro Nakayama, Kawasaki (JP); Shigeki Sekine, Kawasaki (JP)

(73) Assignee: FUJITSU LIMITED, Kawasaki-shi (JP)

(21) Appl. No.: 13/283,327

(22) Filed: Oct. 27, 2011

(30) Foreign Application Priority Data
Nov. 22, 2010 (JP) 2010-260613

(51) Int. Cl. G06F 3/00

(52) U.S. Cl. 710/38

(57) ABSTRACT

An extension device that extends a communication path between a host device and an input/output (IO) device, the extension device including a determination unit configured to determine whether a first logical path exists between the host device and the IO device, a logical path establishment unit configured to request the IO device to establish a second logical path between the extension device and the IO device when the first logical path does not exist between the host device and the IO device, and a communication check unit configured to check communication on the second logical path established between the extension device and the IO device that establishes the second logical path.

### CROSS-REFERENCE TO RELATED APPLICATION

This application is based upon and claims priority to prior Japanese Patent Application No. 2010-260613 filed on Nov. 22, 2010 in the Japan Patent Office, the entire contents of which are incorporated herein by reference.

### FIELD

Embodiments disclosed herein relate to an extension device that extends a communication path between a host device input/output (IO) device, and a communication check method.

### BACKGROUND

A technology in which a communication path to couple a host device to an IO device being extended with an extension device to extend a physical connection distance between the host device and the IO device is known.

In a channel extension system illustrated in FIG. 1, a host device 11 and a channel (CH) side extension device 12 are coupled through an optical channel such as an Optical Channel LINK (OCLINK), and an IO-side extension device 14 and an IO device 13 are coupled through an electrical channel such as a Block Multiplexer Channel (BMC). In addition, the CH-side extension device 12 and the IO-side extension device 14 are coupled through a network 15.

For example, as illustrated in FIG. 1, when a mixed channel extension system of the BMC and the OCLINK are constructed, procedures described below are performed for checking communication in the system.

A communication check of the OCLINK coupling the host device 11 and the CH-side extension device 12 is performed, and then a communication check of the BMC which couples the IO-side extension device 14 and the IO device 13 is performed. Thereafter, a communication check between the CH-side extension device 12 and the IO-side extension device 14 is performed. Then, a communication check between the host device 11 and the IO device 13 is performed. As described above, in the system of FIG. 1, each of the communication checks are performed separately, and then the communication check of the entire channel extension system is performed.

A technology of a channel extension system is described, for example, in Japanese Unexamined Patent Application Publication No. 2006-235665.

When the host device and the IO device are coupled through an OCLINK and communication between the host device and the IO device is performed, a logical path is desired to be established between the host device and the IO device in accordance with regulation of an OCLINK.

In addition, in a channel extension system in which an OCLINK is used, that is, a channel extension system in which the host device and CH-side extension device are coupled through an OCLINK and in which the IO-side extension device and the IO device are also coupled through an OCLINK, a logical path is desired to be established between the IO-side extension device and the IO device in accordance with the regulation of an OCLINK to perform a communication check between the IO-side extension device and the IO device.

Thus, conventionally the related art, the communication check between the IO-side extension device and the IO device is not performed independently of the host-side devices, that is, the host device and the CH-side extension device.

The embodiments disclosed herein provide a device in which the communication check between the IO-side extension device and the IO device may be performed independently of the host-side devices.

### SUMMARY

According to an aspect of the invention, an extension device that extends a communication path between a host device and an IO device includes a determination unit configured to determine whether a first logical path exists between the host device and the IO device, a logical path establishment unit configured to request the IO device to establish a second logical path between the extension device and the IO device when the first logical path does not exist between the host device and the IO device, and a communication check unit configured to check communication on the second logical path established between the extension device and the IO device.

The object and advantages of the invention will be realized and attained by at least the features, elements, and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a configuration of a channel extension system;

FIG. 2 illustrates a configuration of a channel extension system according to an embodiment;

FIG. 3 illustrates a flowchart of an introduction process of host-side devices in the channel extension system according to the embodiment;

FIG. 4 illustrates a flowchart of an introduction process of IO-side devices in the channel extension system according to the embodiment;

FIG. 5 illustrates a configuration of an IO-side extension device according to the embodiment;

FIG. 6 illustrates an example of a logical path management table according to the embodiment;

FIG. 7 illustrates a flowchart of a communication check process according to the embodiment;

FIG. 8 illustrates a sequence diagram of the communication check process according to the embodiment when a logical path exists;

FIG. 9 illustrates a sequence diagram of the communication check process according to the embodiment when a logical path does not exist; and

FIG. 10 illustrates a configuration of a channel extension system according to another embodiment.

### DESCRIPTION OF EMBODIMENTS

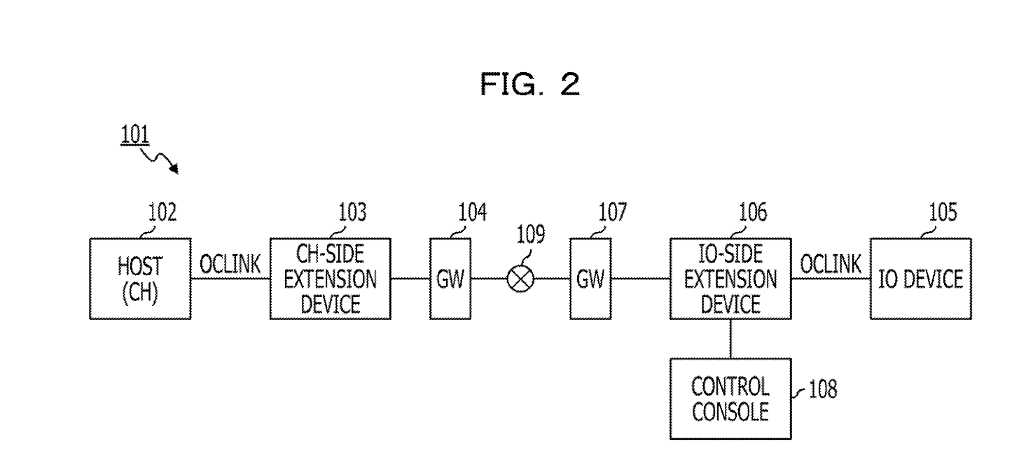

FIG. 2 illustrates a configuration of a channel extension system according to an embodiment.

A channel extension system 101 illustrated in FIG. 2 includes a host device 102, a CH-side extension device 103, a CH-side gateway (GW) 104, an IO device 105, an IO-side extension device 106, an IO-side GW 107 and a control console 108.

The host device 102 may be an information processing device, and performs IO request of data to the IO device 105.

The host device 102 is coupled to the CH-side extension device 103 through an OCLINK.

The host device 102 may also be referred to as a channel (CH). The CH-side extension device 103 couples the host device 102 and the CH-side GW 104. The CH-side extension device 103 operates as a pseudo IO device to the host device 102.

The CH-side GW 104 couples the CH-side extension device 103 to a network 109 and includes a function that converts a communication protocol. The network 109 is, for example, a local area network (LAN) or a wide area network (WAN).

The host device 102 inputs data to the device 105. In addition, the IO device 105 outputs data to the host device 102. The IO device 105 is coupled to the IO-side extension device 106 through an OCLINK. The IO device 105 may be, for example, a magnetic disk device or a semiconductor storage device, however, the IO device 105 may be another IO device.

The IO-side extension device 106 couples the IO device 105 to the IO-side GW 107 and operates as a pseudo host device to the IO device 105. In addition, the IO-side extension device 106 includes a function to determine communication between the IO-side extension device 106 and the IO device 105.

The IO-side GW 107 couples the IO-side extension device 106 to the network 109 and converts a communication protocol.

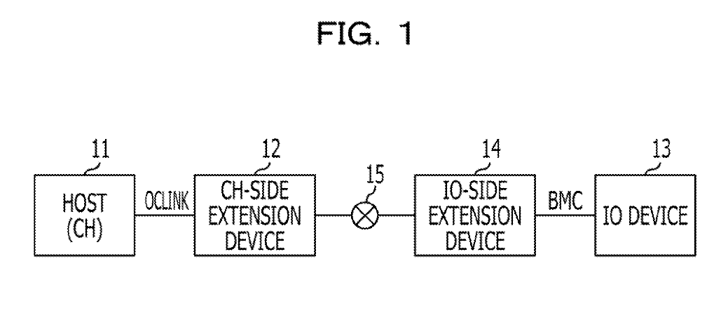

The control console 108 may be coupled to the IO-side extension device 106 through a serial cable, for example. The control console 108 inputs a communication check command to the IO-side extension device 106 and displays various processing results. In the example of FIG. 1, the control console 108 and the IO-side extension device 106 are coupled through the network 109. Alternatively the IO-side extension device 106 may be controlled by, e.g., Telnet or Secure Shell (SSH).

Procedures for introducing devices in a channel extension system according to the embodiment are described.

An introduction process of the host-side devices is described below.

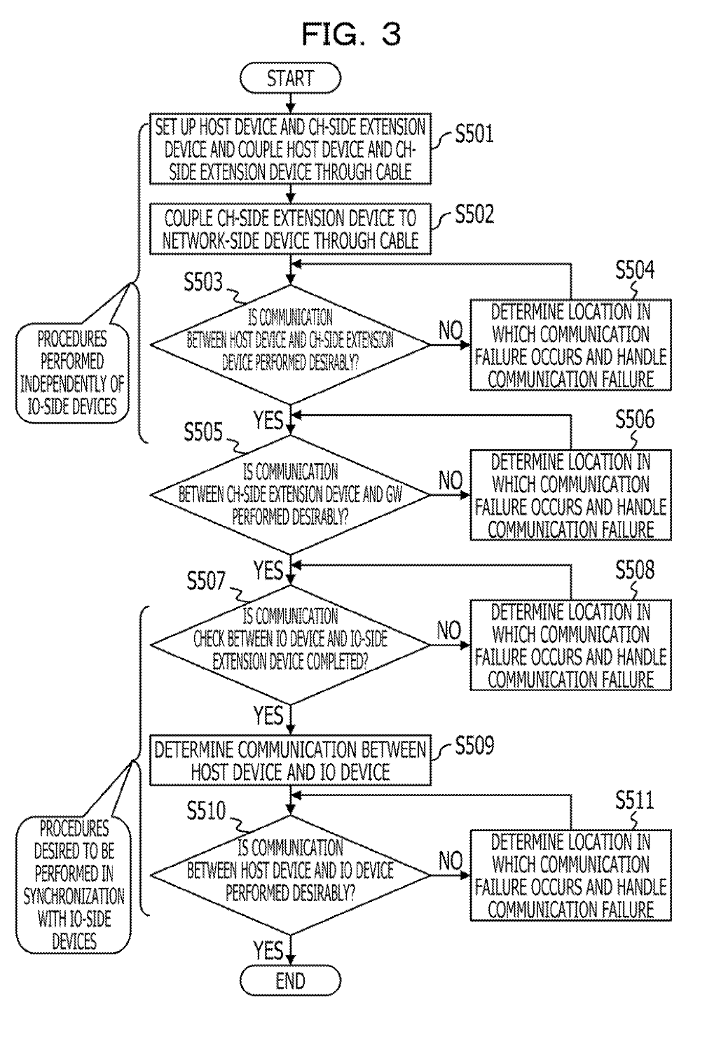

FIG. 3 illustrates a flowchart of the introduction process of the host-side devices in the channel extension system according to the embodiment.

The host device 102 and the CH-side extension device 103 are set up and coupled through a cable (S501).

Then, the CH-side extension device 103 and the network-side device (GW 104) are coupled through a cable (S502). As a result, the host device 102 and the GW 104 are coupled.

Then, a communication test between the coupled devices is performed. In an example of FIG. 3, a communication test between the host device 102 and the CH-side extension device 103 is performed first, and it is determined whether communication between the host device 102 and the CH-side extension device 103 is performed desirably (S503). When the communication between the host device 102 and the CH-side extension device 103 is not performed desirably (No, in S503), the location in which the communication failure occurs is determined and the communication failure is handled (S504). When the communication between the host device 102 and the CH-side extension device 103 is performed desirably (Yes, in S503), the process proceeds to (S505).

After that, the communication test between the CH-side extension device 103 and the GW 104 is performed, and it is determined whether communication between the CH-side extension device 103 and the GW 104 is performed desirably (S505). When the communication between the CH-side extension device 103 and the GW 104 is not performed desirably (No in S505), the location in which the communication failure occurs is determined and the communication failure is handled (S506). When the communication between the CH-side extension device 103 and the GW 104 is performed desirably (Yes in S505), the process proceeds to (S507).

Then, it is determined whether a communication check between the IO device 105 and the IO-side extension device 106 is completed (S507). When the communication check between the devices is not completed (No, in S507), the location in which the communication failure occurs is determined and the communication failure is handled (S508). When the communication check between the devices is completed (Yes, in S507), the process proceeds to (S509).

Thereafter, communication between the host device 102 and the IO device 105 is determined (S509). That is, it is determined whether the communication between the host device 102 and the IO device 105 is performed desirably (S510). When the communication between the devices is performed desirably (Yes in S510), the process ends. When the communication between the devices is not performed desirably (No in S510), the location in which the communication failure occurs is determined and the communication failure is handled (S511).

The introduction of the host-side devices is completed by the above-described process.

Procedures for introducing the IO-side devices are described below.

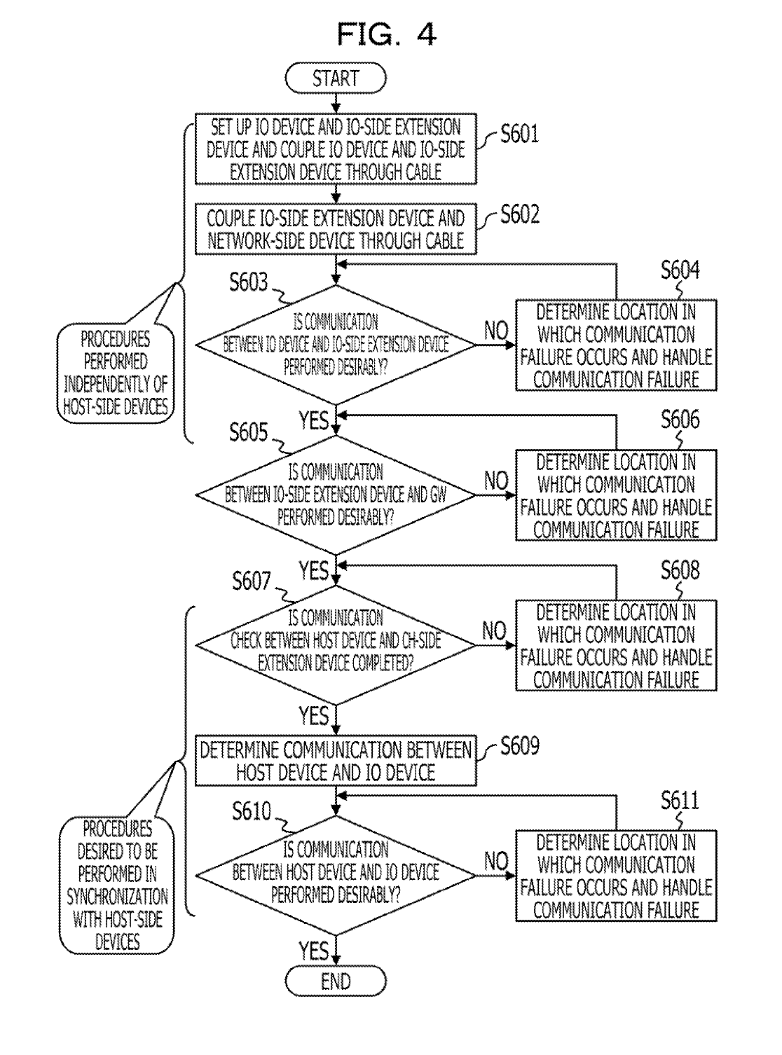

FIG. 4 illustrates a flowchart of an introduction process of the IO-side devices in the channel extension system according to the embodiment.

The IO device 105 and the IO-side extension device 106 are set up and coupled through a cable (S601).

Then, the IO-side extension device 106 and the network-side device (GW 107) are coupled through a cable (S602).

Then, a communication test between the coupled devices is performed. In an example of FIG. 4, it is determined whether communication between the IO device 105 and the IO-side extension device 106 is performed desirably (S603). When the communication between the IO device 105 and the IO-side extension device 106 is not performed desirably (No in S603), the location in which the communication failure occurs is determined and the communication failure is handled (S604). When the communication between the IO device 105 and the IO-side extension device 106 is performed desirably (Yes in S603), the process proceeds to (S605).

Then, it is determined whether communication between the IO-side extension device 106 and the GW 107 is performed desirably (S605). When the communication between the IO-side extension device 106 and the GW 107 is not performed desirably (No in S605), the location in which the communication failure occurs is determined and the communication failure is handled (S606). When the communication between the IO-side extension device 106 and the GW 107 is performed desirably (Yes in S605), the process proceeds to (S607).

Then, it is determined whether communication check between the host device 102 and the CH-side extension device 103 is completed (S607). When the communication check between the host device 102 and the CH-side extension device 103 is not completed (No, in S607), the location in which the communication failure occurs is determined and the communication failure is handled (S608). When the communication check between the host device 102 and the CH-side extension device 103 is completed (Yes, in S607), the process proceeds to (S609).

Thereafter, communication between the host device 102 and the IO device 105 is determined (S609). That is, it is determined whether the communication between the host device 102 and the IO device 105 is performed desirably (S610). When the communication between the devices is performed desirably (Yes in S610), the process ends. When the communication between the devices is not performed desirably (No in S610), the location in which the communication failure occurs is determined and the communication failure is handled (S611).

The introduction of the IO-side devices is completed by the above-described process. A communication check between the IO-side extension device 106 and the IO device 105 that is described below is the process performed in S603 of FIG. 4.

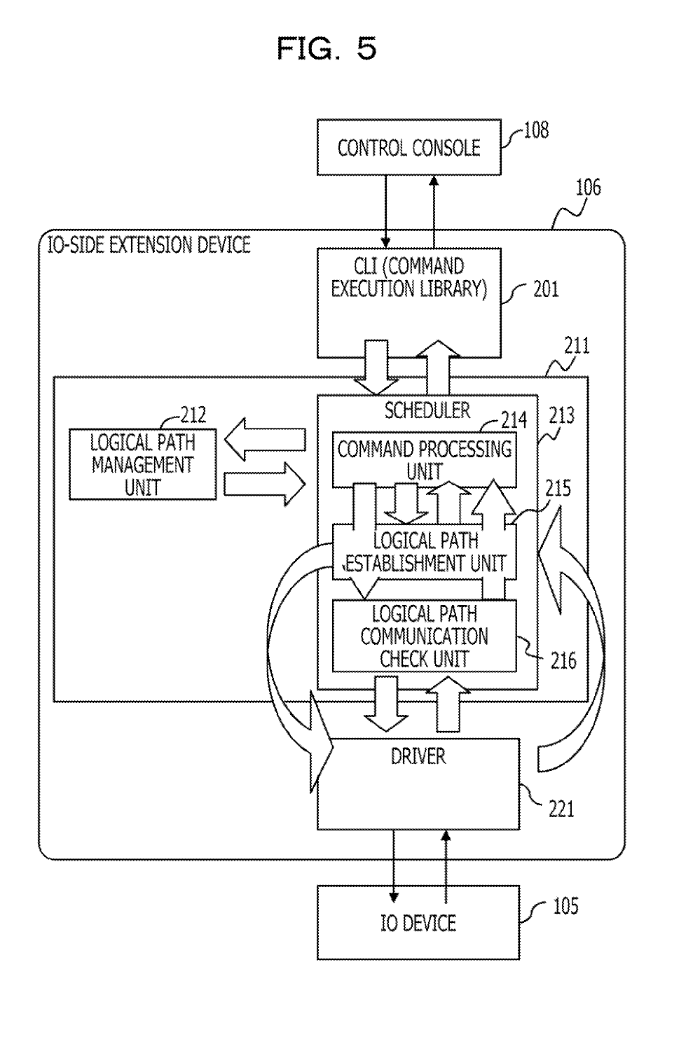

FIG. 5 illustrates a configuration of the IO-side extension device according to the embodiment.

The IO-side extension device 106 includes a command execution library (CLI) 201, an application unit 211, and a driver 221. Elements inside the IO-side extension device 106 illustrated in FIG. 5 correspond to functions achieved when a CPU (not illustrated) included in the IO-side extension device 106 executes a program, etc.

The CLI 201 obtains information of a command input from the control console 108 and outputs the information to the application unit 211.

The application unit 211 includes a logical path management unit 212 and a scheduler 213.

The logical path management unit 212 has a function to refer to a logical path management table that stores information for managing a logical path, and to determine whether a logical path exists, e.g., determine whether a logical path has been established. The logical path management table is stored, for example, in a memory (not illustrated) included in the logical path management unit 212 or the IO-side extension device 106. The logical path management table is described in detail later.

The scheduler 213 includes a command processing unit 214, a logical path establishment unit 215 and a logical path communication check unit 216.

The command processing unit 214 includes a function to perform requests, such as a determination request of the presence or absence of a logical path, an establishment request of a logical path, and a request of communication check between the IO-side extension device 106 and the IO device 105.

The logical path establishment unit 215 includes a function to send an establishment request of a logical path to the driver 221.

The logical path communication check unit 216 includes a function to perform a communication check of a logical path. The logical path communication check unit 216 sends a communication check request of a logical path to the driver 221 and determines the success or failure of the communication based on the response.

The driver 221, for example, sends an establishment request of a logical path and a frame for communication check to the IO device 105.

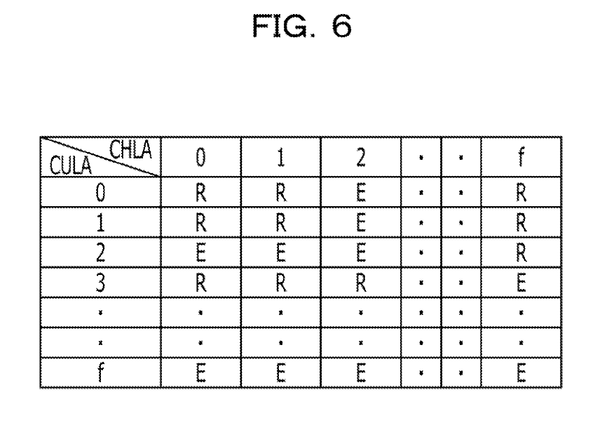

FIG. 6 illustrates an example of the logical path management table according to the embodiment.

In the logical path management table, a logical address (CULA) of the IO device 105 is set as an item of the row, and a logical address (CHLA) of the host device 102 or the IO-side extension device 106 is set as an item of the column as illustrated in FIG. 6.

In the logical path management table, information is recorded that indicates whether a logical path is established between the IO device 105 having a certain logical address and the host device 102 or the IO-side extension device 106 having a certain logical address.

In FIG. 6, “E” indicates that a logical path is established, that is, a logical path exists. In addition, “R” indicates that a logical path is not established, that is, a logical path does not exist.

In FIG. 6, a status of a logical path between the host device (or the IO-side extension device) having a logical address “0” and the IO device having a logical address “0” is “R”, and the “R” indicates that the logical path is not established between the host device (or the IO-side extension device) and the IO device.

In addition, for example, a status of a logical path between the host device (or the IO-side extension device) having a logical address “0” and the IO device having a logical address “2” is “E”, and the “E” indicates that a logical path is established between the host device (or the IO-side extension device) and the IO device.

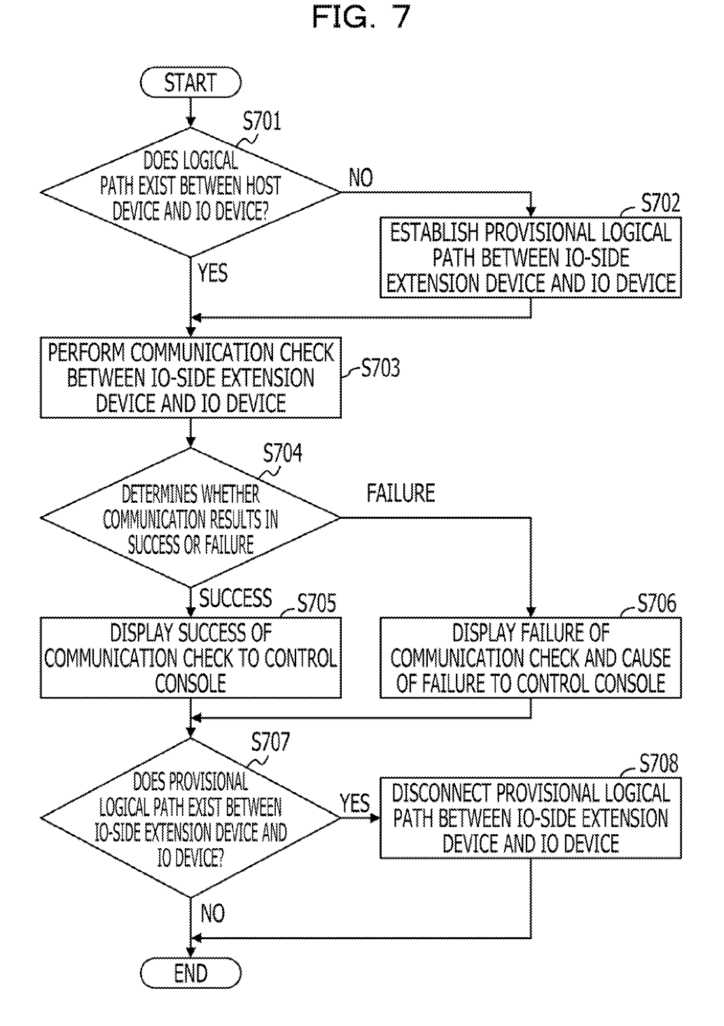

FIG. 7 illustrates a flowchart of a communication check process according to the embodiment.

When a communication check command is input from the control console 108 to the CLI 201 by the operator, the CLI 201 inputs the communication check command to the command processing unit 214.

In S701, the command processing unit 214 requests the logical path management unit 212 to determine whether a logical path exists. When the logical path management unit 212 receives the determination request, the logical path management unit 212 refers to the logical path management table, determines whether a logical path exists between the host device 102 and the IO device 105, and sends the determination result back to the command processing unit 214. When it is determined that a logical path exists between the host device 102 and the IO device 105, the flow proceeds to S703. When it is determined that a logical path does not exist between the host device 102 and the IO device 105, the flow proceeds to S702.

In S702, the command processing unit 214 requests the logical path establishment unit 215 to establish a provisional logical path between the IO-side extension device 106 and the IO device 105. The logical path establishment unit 215 sends an output control command for outputting the establishment request of a provisional logical path to the IO device 105, to the driver 221. The driver 221 sends the establishment request of a provisional logical path to the IO device 105. The IO device 105 establishes a provisional logical path between the IO-side extension device 106 and the IO device 105 and sends the result back to the driver 221. When the driver 221 receives the establishment response of the provisional logical path from the IO device 105, the driver 221 sends the establishment response of the provisional logical path back to the logical path establishment unit 215. The logical path establishment unit 215 sends the establishment completion of the provisional logical path back to the command processing unit 214. The command processing unit 214 sends the establishment of the provisional logical path to the logical path management unit 212. The logical path management unit 212 records the establishment of the provisional logical path in the logical path management table.

In S703, the command processing unit 214 requests the logical path communication check unit 216 to perform a communication check between the IO-side extension device 106 and the IO device 105. The logical path communication check unit 216 sends the communication check request to the driver 221. The driver 221 sends a communication check frame to the IO device 105. When the IO device 105 receives the communication check frame, the IO device 105 sends a communication response frame to the driver 221. The driver 221 sends the communication response from the IO device 105 back to the logical path communication check unit 216.

In S704, the logical path communication check unit 216 determines the result of the communication check and sends the result of the communication check to the command processing unit 214. When the communication check results in success, the flow proceeds to S705. When the communication check results in failure, the flow proceeds to S706. The logical path communication check unit 216 determines that the communication check results in success, for example, when the logical path communication check unit 216 receives the communication response within a certain time period after the communication check request is sent. In addition, the logical path communication check unit 216 determines that the communication check results in failure, for example, when the logical path communication check unit 216 does not receive the communication response within the certain time period after the communication check request is sent.

In S705, the command processing unit 214 requests the CLI 201 to display the success of the communication check. The CLI 201 sends the display of the success of the communication check to the control console 108 in response to the request from the command processing unit 214. The control console 108 performs the display of the success of the communication check on a display (not illustrated), for example.

In S706, the command processing unit 214 requests the CLI 201 to display the failure of the communication check and the cause of the failure. The CLI 201 sends the display of the failure of the communication check and the cause of the failure, to the control console 108. The control console 108 performs the display of the failure of the communication check and the cause of the failure.

In S707, the command processing unit 214 requests the logical path management unit 212 to determine whether a provisional logical path exists between the IO-side extension device 106 and the IO device 105. When the logical path management unit 212 receives the determination request, the logical path management unit 212 refers to the logical path management table, determines whether the provisional logical path exist, and sends the determination result back to the command processing unit 214. When it is determined that the provisional logical path exists, the flow proceeds to S708. When it is determined that the provisional logical path does not exist, the process terminates.

In S708, the command processing unit 214 requests the logical path establishment unit 215 to disconnect the provisional logical path between the IO-side extension device 106 and the IO device 105. The logical path establishment unit 215 sends an output control command for outputting the disconnection request of the provisional logical path to the IO device 105 in response to the request from the command processing unit 214, to the driver 221.

The driver 221 sends the disconnection request of the provisional logical path to the IO device 105. The IO device 105 disconnects the provisional logical path between the IO-side extension device 106 and the IO device 105 and sends the result back to the driver 221. The driver 221 receives the disconnection response of the provisional logical path from the IO device 105 and sends the disconnection response of the provisional logical path back to the logical path establishment unit 215. The logical path establishment unit 215 sends the disconnection completion of the provisional logical path back to the command processing unit 214. The command processing unit 214 sends the disconnection of the provisional logical path to the logical path management unit 212. The logical path management unit 212 records information indicating the provisional logical path is not established on the logical path management table.

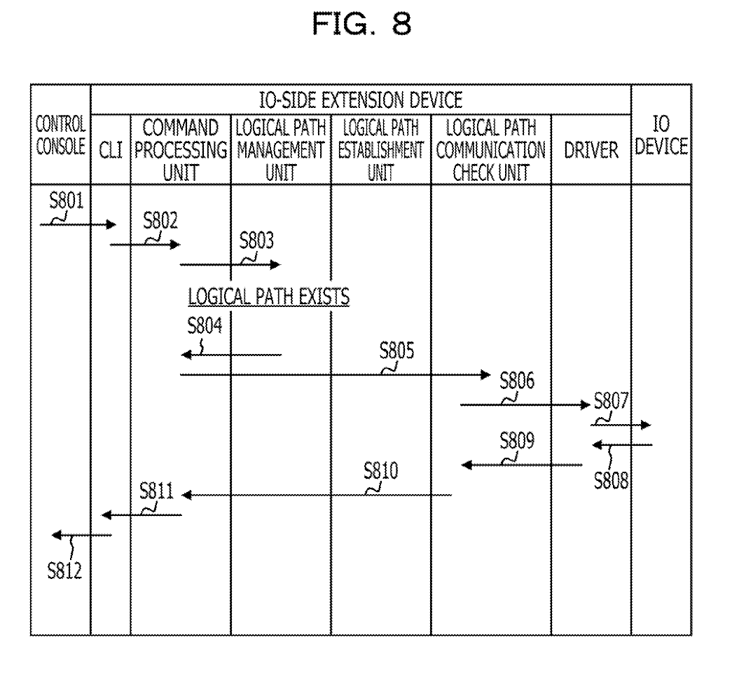

FIG. 8 illustrates a sequence diagram of the communication check process according to the embodiment when a logical path exists.

In S801, a communication check command received in the control console 108 is input to the CLI 201.

In S802, the CLI 201 inputs the communication check command to the command processing unit 214.

In S803, the command processing unit 214 requests the logical path management unit 212 to determine whether a logical path exists between the host device 102 and the IO device 105.

In S804, the logical path management unit 212 sends the presence of a logical path as the determination result back to the command processing unit 214.

In S805, the command processing unit 214 requests the logical path communication check unit 216 to perform a communication check between the IO-side extension device 106 and the IO device 105.

In S806, the logical path communication check unit 216 sends the communication check request to the driver 221.

In S807, the driver 221 sends a communication check frame to the IO device 105.

In S808, the IO device 105 sends a communication response frame back to the driver 221.

In S809, the driver 221 sends the communication response back to the logical path communication check unit 216.

In S810, the logical path communication check unit 216 determines the result of the communication check and sends the result of the communication check back to the command processing unit 214.

In S811, the command processing unit 214 requests the CLI 201 to display the result of the communication check.

In S812, the CLI 201 sends the display of the result of the communication check to the control console 108. The communication check result is displayed, e.g. on a display (not illustrated), in the control console 108.

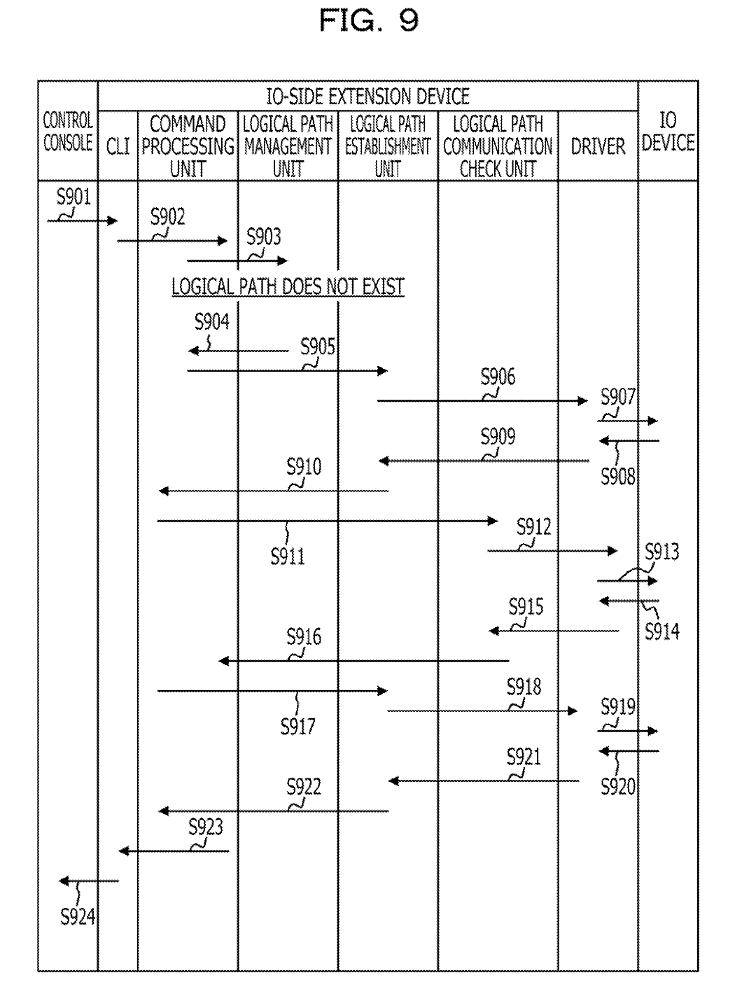

FIG. 9 illustrates a sequence diagram of the communication check process according to the embodiment when a logical path does not exist.

In S901, a communication check command received in the control console 108 is input to the CLI 201.

In S902, the CLI 201 inputs the communication check command input in S901 to the command processing unit 214.

In S903, the command processing unit 214 requests the logical path management unit 212 to determine whether a logical path exists between the host device 102 and the IO device 105.

In S904, the logical path management unit 212 sends the absence of the logical path as the determination result back to the command processing unit 214.

In S905, the command processing unit 214 requests the logical path establishment unit 215 to establish a provisional logical path between the IO-side extension device 106 and the IO device 105.

In S906, the logical path establishment unit 215 sends an output control command for outputting the establishment request of a provisional logical path to the IO device 105, to the driver 221.

In S907, the driver 221 sends the establishment request of a provisional logical path to the IO device 105.

In S908, the IO device 105 establishes a provisional logical path between the IO-side extension device 106 and the IO device 105 and sends the establishment back to the driver 221.

In S909, the driver 221 receives the establishment response of the provisional logical path from the IO device 105, and sends the establishment response of the provisional logical path back to the logical path establishment unit 215.

In S910, the logical path establishment unit 215 sends the establishment completion of the provisional logical path back to the command processing unit 214.

In S911, the command processing unit 214 requests the logical path communication check unit 216 to perform communication check between the IO-side extension device 106 and the IO device 105.

In S912, the logical path communication check unit 216 sends the communication check request to the driver 221.

In S913, the driver 221 sends a communication check frame to the IO device 105.

In S914, the IO device 105 sends the communication response frame to the driver 221.

In S915, the driver 221 sends the communication response back to the logical path communication check unit 216.

In S916, the logical path communication check unit 216 determines the result of the communication check and sends the result of the communication check to the command processing unit 214.

In S917, the command processing unit 214 requests the logical path establishment unit 215 to disconnect the provisional logical path between the IO-side extension device 106 and the IO device 105.

In S918, the logical path establishment unit 215 sends an output control command for outputting the disconnection request of the provisional logical path to the IO device 105, to the driver 221.

In S919, the driver 221 sends the disconnection request of the provisional logical path to the IO device 105.

In S920, the IO device 105 disconnects the provisional logical path between the IO-side extension device 106 and the IO device 105, and sends the result back to the driver 221.

In S921, the driver 221 receives the disconnection response of the provisional logical path from the IO device 105, and sends the disconnection response of the provisional logical path back to the logical path establishment unit 215.

In S922, the logical path establishment unit 215 sends the disconnection completion of the provisional logical path back to the command processing unit 214.

In S923, the command processing unit 214 requests the CLI 201 to display the result of the communication check.

In S924, the CLI 201 sends the display of the result of the communication check to the control console 108. The control console 108 performs the display, e.g. on a display (not illustrated), of the result of the communication check.

In the extension device according to the embodiment, communication check between the IO-side extension device and the IO device may be performed independently of the host-side devices.

As a result, the operator may perform a communication check between the host device and the IO device, and a location in which communication failure occurs may be found when the communication is not performed desirably, thereby substantially reducing the workload of the operator and improving the working efficiency.

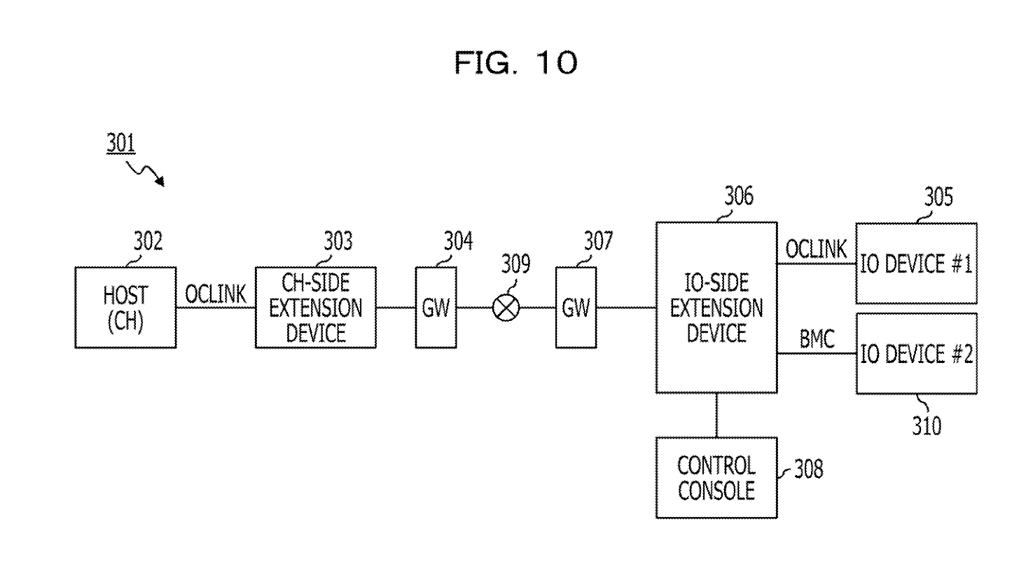

FIG. 10 illustrates a configuration of a channel extension system according to another embodiment.

A channel extension system 301 includes a host device 302, a CH-side extension device 303, a CH-side GW 304, IO devices 305 and 310, an IO-side extension device 306, an IO-side GW 307, and a control console 308.

Each of the host device 302, the CH-side extension device 303, the CH-side GW 304, the IO-side extension device 306, the IO-side GW 307, and the control console 308 is substantially similar to each of the host device 102, the CH-side extension device 103, the CH-side GW 104, the IO-side extension device 106, the IO-side GW 107, and the control console 108 in the above-described channel extension system 101, respectively. Therefore, the descriptions thereof are omitted. The CH-side extension device 303 and the IO-side extension device 306 are coupled through a network 309.

In the channel extension system 301, the two or more IO devices including the IO device 305 and the IO device 310 are coupled to the IO-side extension device 306.

The IO device 305 is coupled to the IO-side extension device 306 through an OCLINK. As a model number (identifier), “#1” is assigned to the IO device 305.

In addition, the IO device 310 is coupled to the IO-side extension device 306 through a BMC. As a model number, “#2” is assigned to the IO device 310.

Similar to the IO-side extension device 106 according to the above-described embodiment, the IO-side extension device 306 requests the IO device to establish a provisional logical path and to disconnect the provisional logical path, and to perform a communication check between the IO-side extension device 306 and the IO device.

In the embodiment, a communication check command from the control console 308 includes a model number indicating a target IO device, and the IO-side extension device 306 performs communication check between the IO-side extension device 306 and an IO device corresponding to the model number included in the communication check command. For example, when a communication check command includes #1 as a model number indicating a target IO device, the IO-side extension device 306 performs a communication check between the IO-side extension device 306 and the IO device 305.

When a communication check command does not include a model number indicating a target IO device, the IO-side extension device 306 may perform a communication check with respect to all IO devices that are coupled to the IO-side extension device 306.

In the extension device according to the embodiment, a communication check may be performed with respect to a certain IO device and to all IO devices that are coupled to the extension device.

Although the embodiments of the present invention are numbered with, for example, “first,” “second,” or “third,” ordinal numbers do not imply priorities of the embodiment. Many other variations and modifications will be apparent to those skilled in the art.

All examples and conditional language recited herein are intended for pedagogical purposes to aid the reader in understanding the aspects of the invention and the concepts contributed by the inventor to furthering the art, and are to be construed as being without limitation to such specifically recited examples and conditions, nor does the organization of such examples in the specification relate to a showing of the superiority and inferiority of the aspects of the invention. Although the embodiment in accordance with aspects of the present invention has been described in detail, it should be understood that various changes, substitutions, and alterations could be made hereto without departing from the spirit and scope of the invention.

What is claimed is:

1. An extension device that extends a communication path between a host device and an input/output device, the extension device comprising:
a determination unit configured to determine whether a first logical path exists between the host device and the IO device;
a logical path establishment unit configured to request the IO device to establish a second logical path between the extension device and the IO device when the first logical path does not exist between the host device and the IO device; and
a communication check unit configured to check communication on the second logical path established between the extension device and the IO device.

2. The extension device according to claim 1, wherein
the communication check unit requests the IO device to delete the second logical path after checking the communication on the second logical path established between the extension device and the IO device.

3. A communication check method performed by an extension device provided on a side of the IO device and that extends a communication path between a host device and an IO device, the communication check method comprising:
determining, by a determination unit, whether a first logical path exists between the host device and the IO device;
requesting, by a logical path establishment unit, the IO device to establish a second logical path between the extension device and the IO device when the first logical path does not exist between the host device and the IO device; and
checking, by a communication check unit, communication on the second logical path established between the extension device and the IO device.

4. The communication check method according to claim 3, wherein
requesting, by the communication check unit, the IO device to delete the second logical path after checking the communication on the second logical path established between the extension device and the IO device.

5. An extension device that extends a communication path between a host device and an input/output device, the extension device comprising:
a processor configured to execute a procedure, the procedure comprising:
determining whether a first logical path exists between the host device and the IO device;
requesting the IO device to establish a second logical path between the extension device and the IO device when the first logical path does not exist between the host device and the IO device; and
checking communication on the second logical path established between the extension device and the IO device.
